(19) United States
(12) Patent Application Publication
(10) Pub. No.: US 2014/0249849 A1
(43) Pub. Date: Sep. 4, 2014

(54) REAL TIME STRATIFICATION OF HEALTH-RELATED DATA

(71) Applicant: CARADIGM USA LLC, Bellevue, WA (US)

(72) Inventors: ADARSH KHARE, ISSAQUAH, WA (US); JADE NAAMAN, BELLEVUE, WA (US); LARRY NICKLAS, RENTON, WA (US); CORINNE PASCALE, BELLEVUE, WA (US); LINDA WALMER, SEATTLE, WA (US)

(73) Assignee: CARADIGM USA LLC, Bellevue, WA (US)

(21) Appl. No.: 13/782,570

(22) Filed: Mar. 1, 2013

(51) Int. Cl. G06F 19/00

(52) U.S. Cl. CPC G06F 19/322
USPC 705/3

(57) ABSTRACT

Computer program products, methods, systems, apparatus, and computing entities are provided for real time stratification of health-related data. In one embodiment, health-related data can be received in real time, after which rules corresponding to the health-related data can be identified. After identification, the rules can be applied to the health-related data to stratify patients into those who may be eligible for participation in and those who are ineligible for participation in one or more care pathways. Then, corresponding tasks can be created for the patients who are eligible for participation in the care pathways.

### BACKGROUND

Care providers need to stratify/classify health-related data to determine eligibility and/or prioritization for various care management pathways, interventions, workflows, programs, and/or the like. Thus, a need exists for a real-time, efficient solution for the stratification/classification of patient/member data.

### BRIEF SUMMARY

In general, embodiments of the present invention provide methods, apparatus, systems, computing devices, computing entities, and/or the like for real time stratification of health-related data.

In accordance with one aspect, a method for real time stratification of health-related data is provided. In one embodiment, the method comprises (1) receiving health-related data (a) corresponding to a plurality of patients (b) originating from a plurality of health-related data sources, the health-related data being received in real time; (2) identifying one or more rules corresponding to the health-related data; (3) applying the one more rules to the health-related data to stratify patients who may be eligible for participation in one or more care pathways and patients who are not eligible for participation in the one or more care pathways; and (4) creating one or more tasks for the patients who may be eligible for participation in the one or more care pathways.

In accordance with another aspect, a computer program product for real time stratification of health-related data is provided. The computer program product may comprise at least one computer-readable storage medium having computer-readable program code portions stored therein, the computer-readable program code portions comprising executable portions configured to (1) receive health-related data (a) corresponding to a plurality of patients (b) originating from a plurality of health-related data sources, the health-related data being received in real time; (2) identify one or more rules corresponding to the health-related data; (3) apply the one more rules to the health-related data to stratify patients who may be eligible for participation in one or more care pathways and patients who are not eligible for participation in the one or more care pathways; and (4) create one or more tasks for the patients who may be eligible for participation in the one or more care pathways.

In accordance with yet another aspect, an apparatus comprising at least one processor and at least one memory including computer program code is provided. In one embodiment, the at least one memory and the computer program code may be configured to, with the processor, cause the apparatus to (1) receive health-related data (a) corresponding to a plurality of patients (b) originating from a plurality of health-related data sources, the health-related data being received in real time; (2) identify one or more rules corresponding to the health-related data; (3) apply the one more rules to the health-related data to stratify patients who may be eligible for participation in one or more care pathways and patients who are not eligible for participation in the one or more care pathways; and (4) create one or more tasks for the patients who may be eligible for participation in the one or more care pathways.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a computing entity according to one embodiment of the present invention.

FIG. 3 is a flowchart illustrating operations and processes that can be used in accordance with various embodiments of the present invention.

FIG. 4 shows exemplary input and output that may be produced in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Computer Program Products, Methods, and Computing Entities

Embodiments of the present invention may be implemented in various ways, including as computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory, multimedia memory cards (MMC), secure digital (SD) memory cards, Memory Sticks, and/or the like. Further, a non-volatile computer-readable storage medium may also include conductive-bridging random access memory (CBRAM), phase-change random access memory (PRAM), ferroelectric random-access memory (FeRAM), resistive random-access memory (RRAM), Silicon-Oxide-Nitride-Oxide-Silicon memory (SONOS), racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Rambus in-line memory module (RIMM), dual in-line memory module (DIMM), single in-line memory module (SIMM), video random access memory VRAM, cache memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Embodiments of the present invention are described below with reference to block diagrams and flowchart illustrations. Thus, it should be understood that each block of the block diagrams and flowchart illustrations, respectively, may be implemented in the form of a computer program product, an entirely hardware embodiment, a combination of hardware and computer program products, and/or apparatus, systems, computing devices, computing entities, and/or the like carrying out instructions on a computer-readable storage medium for execution. Such embodiments can produce specifically-configured machines performing the steps or operations specified in the block diagrams and flowchart illustrations. Accordingly, the block diagrams and flowchart illustrations support various combinations of embodiments for performing the specified steps or operations.

### II. Exemplary System Architecture

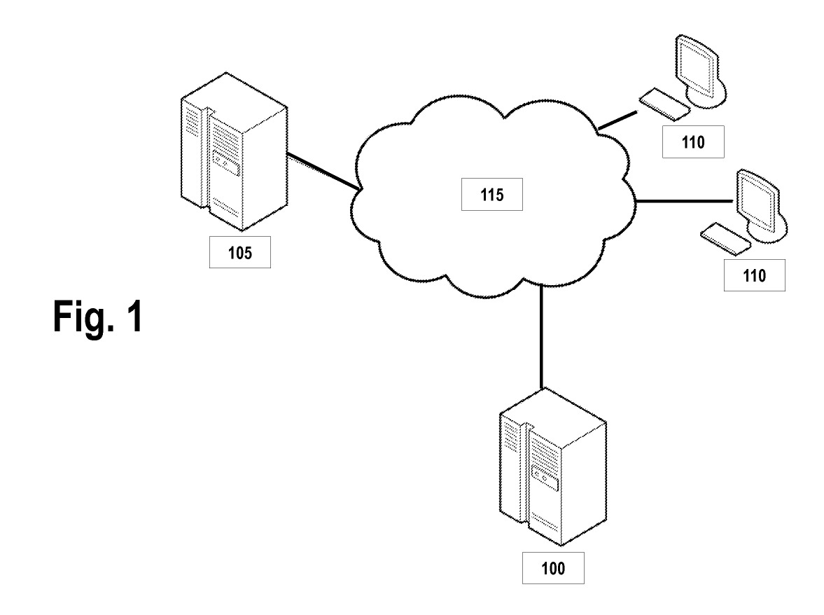

FIG. 1 provides an illustration of an exemplary embodiment of the present invention. As shown in FIG. 1, this particular embodiment may include one or more data management computing entities 100, one or more health-related data source computing entities 105, one or more care provider computing entities 110, and one or more networks 115. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### 1. Data Management Computing Entity

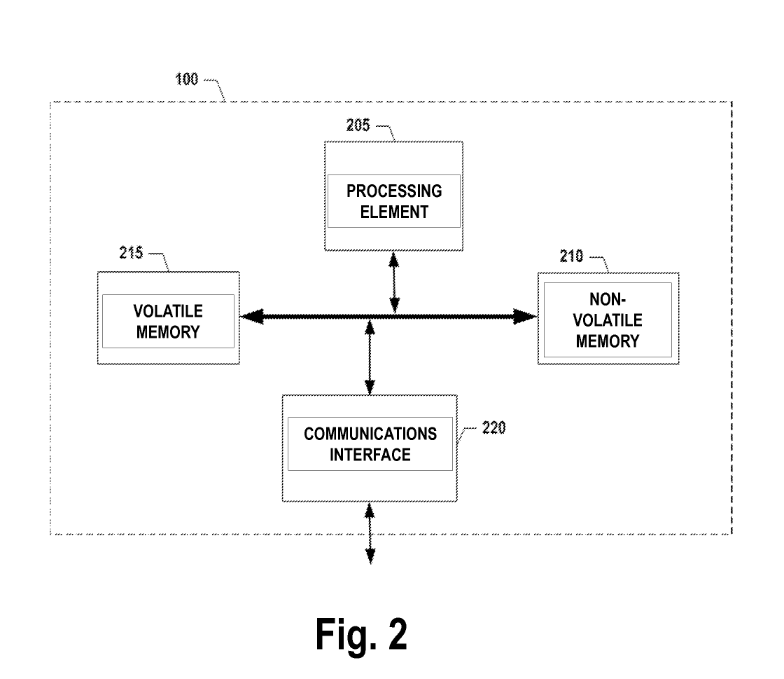

FIG. 2 provides a schematic of a data management computing entity 100 according to one embodiment of the present invention. In general, the terms computing entity, entity, device, system, and/or similar words used herein interchangeably may refer to, for example, one or more computers, computing entities, computing devices, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the data management computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the data management computing entity 100 may communicate with health-related data source computing entities 105 and/or the care provider computing entities 110.

As shown in FIG. 2, in one embodiment, the data management computing entity 100 may include or be in communication with one or more processing elements 205 (also referred to as processors, processing circuitry, and/or similar terms used herein interchangeably) that communicate with other elements within the data management computing entity 100 via a bus, for example. As will be understood, the processing element 205 may be embodied in a number of different ways. For example, the processing element 205 may be embodied as one or more complex programmable logic devices (CPLDs), microprocessors, multi-core processors, coproces sing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the data management computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. Such code may include a rules engine for applying one or more rules or one or more sets of rules. The term database, database instance, database management system, and/or similar terms used herein interchangeably may refer to a structured collection of records or data that is stored in a computer-readable storage medium, such as via a relational database, hierarchical database, and/or network database.

In one embodiment, the data management computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the data management computing entity 100 with the assistance of the processing element 205 and operating system, such as the rules engine applying one or more rules or one or more sets of rules.

As indicated, in one embodiment, the data management computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the data management computing entity 100 may receive health-related data originating from health-related data source computing entities 105 and provide data to care provider computing entities 110. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the data management computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Although not shown, the data management computing entity 100 may include or be in communication with one or more input elements, such as a keyboard input, a mouse input, a touch screen/display input, audio input, pointing device input, joystick input, keypad input, and/or the like. The data management computing entity 100 may also include or be in communication with one or more output elements (not shown), such as audio output, video output, screen/display output, motion output, movement output, and/or the like.

As will be appreciated, one or more of the computing entity's 100 components may be located remotely from other data management computing entity 100 components, such as in a distributed system. Furthermore, one or more of the components may be combined and additional components performing functions described herein may be included in the data management computing entity 100. Thus, the data management computing entity 100 can be adapted to accommodate a variety of needs and circumstances.

### 2. Exemplary Health-Related Data Source Computing Entity

Health-related data source computing entities 105 can be associated with and provide health-related data sources to provide health-related data to the data management computing entity 100 on a routine, periodic, and/or continuous basis in real time. Such health-related data sources may be facilities, laboratories, clinics, pharmacies, weather information providers, claim processors, insurance providers, care providers, and/or the like. For example, the health-related data source computing entity 105 may provide health-related data to the data management computing entity 100 that includes patient/member data, claims data, historical data, external data, and/or the like. To do so, each health-related data source computing entity 105 may include one or more processing elements, one or more display device/input devices, volatile and non-volatile storage or memory, and/or one or more communications interfaces. These architectures are provided for exemplary purposes only and are not limiting to the various embodiments. The term computing entity may refer to one or more computers, computing devices, computing entities, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions described herein.

### 3. Exemplary Care Provider Computing Entity

Care providers may be doctors, nurses, physician assistants, administrative personnel, hospitals, pharmacies, insurance providers, care managers, and/or other healthcare-related entities or professionals. Care providers may be associated with one or more different care provider computing entities 110 that may be used in connection with various embodiments of the present invention. In one embodiment, each care provider computing entity 110 may include one or more processing elements, one or more display device/input devices, volatile and non-volatile storage or memory, and/or one or more communications interfaces. These architectures are provided for exemplary purposes only and are not limiting to the various embodiments. The term computing entity may refer to one or more computers, computing devices, computing entities, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions described herein.

### III. Exemplary System Operation

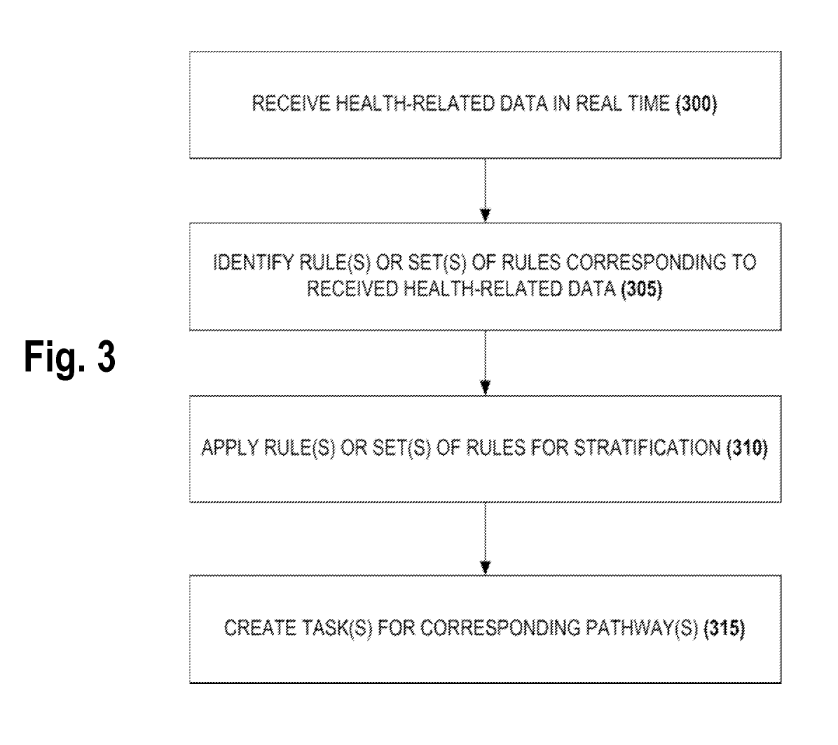

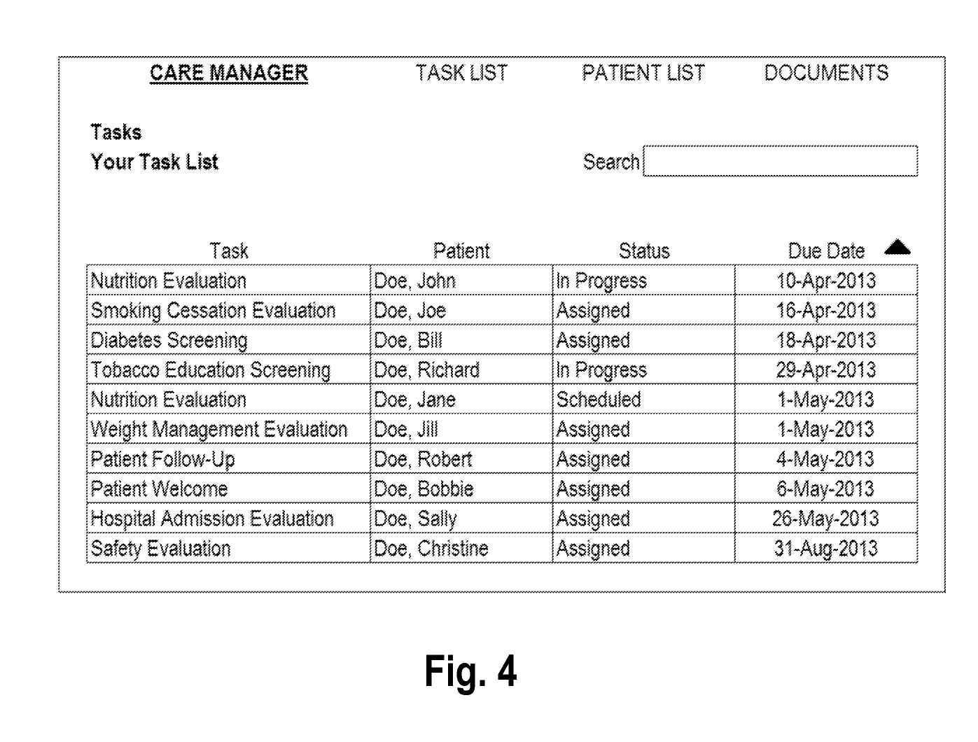

Reference will now be made to FIGS. 3-4. FIG. 3 is a flowchart illustrating operations and processes that may be performed for real time data stratification/classification. FIG. 4 provides exemplary input and output that may be produced in accordance with various embodiments of the present invention.

### 1. Providing and Receiving Health-Related Data

As shown in FIG. 3, the process may begin with one or more health-related data source computing entities 105 providing health-related data to the data management computing entity 100. In one embodiment, such health-related data can be provided to and received by the data management computing entity 100 on a routine basis, periodic basis, and/or continuous basis in real time (Block 300 of FIG. 3). The health-related data may include patient/member data, historical data, claims data, external data, and/or various other types of data.

In one embodiment, patient/member data may include information regarding patients/members. This information may include a patient's/member's name, address, date of birth, medical/customer identification number, health insurance information, health insurance authorizations (e.g., authorizations for durable medical equipment and/or out-patient surgery), Social Security number, medical record number, and/or the like.

In one embodiment, the data management computing entity 100 may also be provided with or receive historical data from an electronic medical record (EMR) of a patient/member, for example. Such historical data may include information regarding surgeries, schedules, treatments, insurance information, payment information, family history, and/or the like.

In one embodiment, the claims data may include information about one or more claims corresponding to a patient/member. A claim may be a request for payment/reimbursement for services rendered, materials used, medication provided or dispensed, equipment provided, and/or the like in connection with treating, monitoring, evaluating, and/or diagnosing an injury, illness, condition, and/or concern. For example, a claim may be a request for payment/reimbursement for a consultation with a care provider, a medical procedure or an evaluation performed by an orthopedic surgeon, a laboratory test performed by a laboratory, durable medical equipment provided to an injured patient/member, medications or other materials used in the treatment of a patient/member, and/or the like.

In embodiment, external data may include data from various external data providers. Such data may include census data, state cancer profile data, disease outbreak data, chemical or toxic exposure data, demographic data, vital statistics data, and/or the like. The external data may also include weather-related data, such as data associated with thunderstorms, hurricanes, pollen levels, precipitation, cold fronts, heat waves, tornados, changes in barometric pressure, and/or the like. As will be recognized, health-related data may include data from various sources for a variety of reasons.

### 2. Stratification/Classification: Applying Rule(s) or Sets of Rule(s) to Health-Related Data

In one embodiment, after receiving health-related data, the data management computing entity 100 can access, process, analyze, and/or apply one or more rules and/or one or more sets of rules (e.g., via a rules engine) to the health-related data in real time to stratify/classify patients/members into those who may be eligible for participation in and those who are ineligible for participation in one or more care pathways. The stratification/classification of the health-related data may also include prioritizing the patients/members and/or the care pathways for which they are eligible. To do so, the data management computing entity 100 can identify (a) changes, additions, updates, and/or removals, for example, in or to the health-related data that has been received and (b) the rules or sets of rules corresponding to the same (Block 305 of FIG. 3). Additionally, the data management computing entity 100 may retrieve additional data required to apply rules as described in Block 310 of FIG. 3. As indicated in Block 310 of FIG. 3, the data management computing entity 100 can then apply the one or more identified rules and/or the one or more identified sets of rules to only the health-related data that includes, for example, changes to, additions to, updates to, and/or removals of the health-related data (or to all the health-related data that has been received). Such changes, additions, updates, and/or removals may indicate that a new patient/member has been enrolled in health plan for health insurance coverage. Such changes, additions, updates, and/or removals may indicate that a pharmacy claim for a patient/member taking Lipitor, for example, has been processed. Such changes, additions, updates, and/or removals may indicate that a patient/member has been admitted to a hospital or an insurance report that a patient/member has been involved in a vehicle accident. Other changes, additions, updates, and/or removals may indicate that a patient/member has been treated for an illness or injury, received a checkup for an existing condition, laboratory results that have been generated, and/or the like. This approach may allow, for example, an employer or care provider to target conditions, such as congestive heart failure (COH), chronic obstructive pulmonary disease (COPD), or high utilization of coverage, for certain care pathways.

In one embodiment, based on the identification of changes to, additions to, updates to, and/or removals of the received health-related data, the data management computing entity 100 can determine whether the patient's/member's record warrants evaluation for eligibility/ineligibility/prioritization, and if so, then apply the appropriate rules or sets of rules accordingly (e.g., stratify/classify patients/members into those who may be eligible for participation in and those who are ineligible for participation in one or more care pathways). As will be recognized, a rule or set of rules may be a logical analysis performed by the data management computing entity 100 to make decisions in real time. The rules and sets of rules can predefined and/or be customized to adapt to various needs and circumstances. Similarly, the rules and sets of rules can be revised and changed to obtain desired outcomes. For instance, the rules are easily malleable such that a targeted condition may move from COPD to Diabetes based on season or the goals of a care site for a given year. It may further be the change of a cost threshold from one monetary amount to another monetary amount that now makes the patient eligible or changes his/her priority.

In one embodiment, the rules and sets of rules can be applied to the health-related data (which may include accessing additional information regarding the patient) to determine whether a patient/member is eligible or ineligible for one or more care pathways, workflows, intervention, programs, and/or similar terms used herein interchangeably. Such care pathways can be put in place to manage the care of patients/members, for example. For instance, one or more care pathways may be created for patients/members who have diabetes (these care pathways corresponding to specific rules or rule sets for determining eligibility and/or prioritization). Patients/members who have diabetes may be candidates for a weight management care pathway and/or a nutrition care pathway. Such care pathways may be used to monitor food intake, sugar intake, exercise habits, and/or the like. Similarly, patients/members who are smokers may be candidates for a smoking education or prevention care pathway. A smoking care pathway may be for educating patients/members about the negative effects of smoking or assisting patients/members in stopping smoking. As another example, when patients/members are initially enrolled in health plans for health insurance coverage, the patients/members may be eligible for a welcoming care pathway designed to reach out and welcome new patients/members to instruct them how to obtain medical treatment. Some care pathways may be follow-ups to inpatient stay or admission to a facility. They may target special-needs patients/members or patients/members known to be at high risk, and follow-on to them with the assistance of a care manager. As will be recognized, a variety of other care pathways can be used to adapt to various needs and circumstances.

In one embodiment, to determine whether a patient/member is eligible for one or more care pathways, the data management computing entity 100 can apply one or more rules or one or more sets of rules that correspond to the change to, addition to, update to, and/or removal of health-related data (which may include accessing additional information regarding the patient). For example, if the data management computing entity 100 receives claims data indicating that a patient/member had a prescription filled for insulin, the data management computing entity 100 may apply one or more rules to determine whether the patient/member is eligible for a weight management care pathway and/or a nutrition care pathway for patients with diabetes. Thus, the changes to, additions to, updates to, and/or removals of health-related data may dictate what rules or sets of rules are to be applied to the health-related data for determining eligibility and/or prioritization for different care pathways. For instance, if the data management computing entity 100 receives historical data or medical record data indicating that a patient/member was treated for a tobacco-related condition, the data management computing entity 100 may apply one or more rules to determine whether the patient/member is eligible for a smoking education or prevention care pathway (e.g., stratify/classify patients/members into those who may be eligible for participation in and those who are ineligible for participation in one or more care pathways). By mapping certain changes to, additions to, updates to, and/or removals of health-related data to specific rules or sets of rules, overuse and/or misapplication of the rules can be avoided. For example, rules for determining whether a patient/member is eligible for a maternity care pathway would not be applied to health-related data for males or in response to claims data indicating that a patient/member broke his arm or was treated for the flu.

As will be recognized, determining whether a patient/member is eligible or ineligible for one or more care pathways may not only include determining whether the patient/member is eligible or ineligible based on the changes to, additions to, updates to, and/or removals of health-related data, but also whether, for example, the patient's/member's insurance coverage would cover participation in the one or more care pathways. For instance, in one embodiment, the data management computing entity 100 may not offer care pathways to patients/members unless they are covered by insurance. In another embodiment, though, whether the care pathway is covered by insurance is not considered as a factor.

In one embodiment, the data management computing entity 100 may run a complete analysis on patient data records on a routine, periodic, and/or continuous basis. By doing so, the data management computing entity 100 can identify patients/members who are eligible for care pathways based on changes in rules, for example, or the sum total of changes to, additions to, updates to, and/or removals of the health-related data rather than just based on an individual event in the data feed. Further, in such a case, rules with changes or updates can be reapplied to the health-related data to re-stratifying/re-classifying patients/members into those who may be eligible for participation in and those who are ineligible for participation in one or more care pathways

### 3. Tasks

In one embodiment, after eligibility and/or prioritization are determined (e.g., stratifying/classifying patients/members into those who may be eligible for participation in and those who are ineligible for participation in one or more care pathways), the data management computing entity 100 can create one or more tasks regarding the care pathways for which a patient/member is eligible (Block 315 of FIG. 3) or ineligible. Creating one or more tasks regarding the care pathways for which a patient/member is eligible may include flagging the patient/member for manual review for admission into the care pathway, creating tasks for further automated processing, and/or the like.

In one embodiment, the data management computing entity 100 can pass the tasks into one or more task queues for presentation and/or tracking via a task list, for example. An exemplary task list is provided in FIG. 4. As show in FIG. 4, in this example, the tasks are sorted by due date and have corresponding columns for the task, patient, status, and due date (each of which may allow for sorting based on the same). The tasks may be assigned to specific task queues, such as task queues for a specific care provider (e.g., care manager specializing in diabetes), task queues for certain tasks (e.g., a screening task queue or a follow-up task queue), task queues for certain patients, task queues for certain dates, task queues for certain geographic areas (e.g., regions), and/or the like. In the example shown in FIG. 4, the task queue may correspond to a care manager who has responsibility for this portion of the patient alphabet. As will be recognized, a variety of other approaches and techniques can be used to adapt to various needs and circumstances.

In one embodiment, the tasks can be used to indicate, notify, and/or track tasks that need to be performed, for example, for a given patient, a given patient care pathway, groups of patients, a given patient date, and/or the like. As shown in FIG. 4, the task list shown in FIG. 4 lists 10 tasks that need to be performed: (1) nutrition evaluation for John Doe; (2) smoking cessation evaluation for Joe Doe; (3) diabetes screening for Bill Doe; (4) tobacco education screening for Richard Doe; (5) nutrition evaluation for Jane Doe; (6) weight management evaluation for Jill Doe; (7) patient follow-up for Robert Doe; (8) patient welcome for Bobbie Doe; (9) hospital admission evaluation for Sally Does; and (10) safety evaluation for Christine Doe.

Additionally, the data management computing entity 100 can also reassign, reschedule, and/or remove tasks from task queues. For instance, reassigning, rescheduling, and/or removing tasks from a queue may be the result of application of certain rules or sets of rules. By way of example, a closure care pathway may be an instance in which non-started tasks for a patient/member are closed (and removed from queue) as a result of the patient/member no longer being eligible for the specified care pathway. As will be recognized, a variety of other techniques and approaches can be used to adapt to various needs and circumstances.

In one embodiment, the tasks can then be used to initiate patients/members into to care pathways, monitor their progress in the same, and or assist care providers in organizing and providing the same to patients/members. As will be recognized, a variety of other techniques and approaches can be used to adapt to various needs and circumstances.

### IV. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for real time stratification of health-related data, the method comprising:
receiving, via one or more processors, health-related data (a) corresponding to a plurality of patients (b) originating from a plurality of health-related data sources, the health-related data being received in real time;
identifying, via the one or more processors, one or more rules corresponding to the health-related data;
applying, via the one or more processors, the one more rules to the health-related data to stratify patients who may be eligible for participation in one or more care pathways and patients who are not eligible for participation in the one or more care pathways; and
creating, via the one or more processors, one or more tasks for the patients who may be eligible for participation in the one or more care pathways.

2. The method claim 1, wherein the health-related data is selected from the group consisting of patient data, claims data, historical data, and external data.

3. The method claim 1, wherein the health-related data corresponds to the one more rules.

4. The method claim 1 further comprising:
receiving a change to the one or more rules corresponding to the health-related data; and
reapplying the one more rules with the change to the health-related data to stratify patients who may be eligible for participation in the one or more care pathways and patients who are not eligible for participation in the one or more care pathways.

5. The method of claim 1 further comprising queuing the one or more tasks in a task queue.

6. The method of claim 5, wherein the task queue is selected from the group consisting of a task queue for a care provider, a task queue for certain tasks, a task queue for certain patients, and a task queue for certain dates.

7. An apparatus comprising at least one processor and at least one memory including computer program code, the at least one memory and the computer program code configured to, with the processor, cause the apparatus to at least:
receive health-related data (a) corresponding to a plurality of patients (b) originating from a plurality of health-related data sources, the health-related data being received in real time;
identify one or more rules corresponding to the health-related data;
apply the one more rules to the health-related data to stratify patients who may be eligible for participation in one or more care pathways and patients who are not eligible for participation in the one or more care pathways; and
create one or more tasks for the patients who may be eligible for participation in the one or more care pathways.

8. The apparatus claim 7, wherein the health-related data is selected from the group consisting of patient data, claims data, historical data, and external data.

9. The apparatus claim 7, wherein the health-related data corresponds to the one more rules.

10. The apparatus claim 7, wherein the memory and computer program code are further configured to, with the processor, cause the apparatus to:
receive a change to the one or more rules corresponding to the health-related data; and
reapply the one more rules with the change to the health-related data to stratify patients who may be eligible for participation in the one or more care pathways and patients who are not eligible for participation in the one or more care pathways.

11. The apparatus claim 7, wherein the memory and computer program code are further configured to, with the processor, cause the apparatus to queue the one or more tasks in a task queue.

12. The apparatus claim 11, wherein the task queue is selected from the group consisting of a task queue for a care provider, a task queue for certain tasks, a task queue for certain patients, and a task queue for certain dates.

13. A computer program product for real time stratification of health-related data, the computer program product comprising at least one non-transitory computer-readable storage medium having computer-readable program code portions stored therein, the computer-readable program code portions comprising:
an executable portion configured to receive health-related data (a) corresponding to a plurality of patients (b) originating from a plurality of health-related data sources, the health-related data being received in real time;
an executable portion configured to identify one or more rules corresponding to the health-related data;
an executable portion configured to apply the one more rules to the health-related data to stratify patients who may be eligible for participation in one or more care pathways and patients who are not eligible for participation in the one or more care pathways; and
an executable portion configured to create one or more tasks for the patients who may be eligible for participation in the one or more care pathways.

14. The computer program product claim 13, wherein the health-related data is selected from the group consisting of patient data, claims data, historical data, and external data.

15. The computer program product claim 13, wherein the health-related data corresponds to the one more rules.

16. The computer program product claim 13 further comprising:
an executable portion configured to receive a change to the one or more rules corresponding to the health-related data; and
an executable portion configured to reapply the one more rules with the change to the health-related data to stratify patients who may be eligible for participation in the one or more care pathways and patients who are not eligible for participation in the one or more care pathways.

17. The computer program product claim 13 further comprising an executable portion configured to queue the one or more tasks in a task queue.

18. The computer program product claim 17, wherein the task queue is selected from the group consisting of a task queue for a care provider, a task queue for certain tasks, a task queue for certain patients, and a task queue for certain dates.
